(19) United States
(12) Patent Application Publication
(10) Pub. No.: US 2003/0163610 A1
(43) Pub. Date: Aug. 28, 2003

(54) Computer systems, software and methods for emulating a non-volatile removable media device using material on a mass storage device

(76) Inventor: Curtis E. Stevens, Irvine, CA (US)

Correspondence Address: KIMBERLEY G. NOBLES, IRELL & MANELLA LLP, 840 NEWPORT CENTER DRIVE, SUITE 400, NEWPORT BEACH, CA, 92660, US

(21) Appl. No.: 10/084,548

(22) Filed: Feb. 25, 2002

(51) Int. Cl. G06F 3/00; G06F 9/455

(52) U.S. Cl. 710/8; 703/24

(57) ABSTRACT

Computer systems, software and methods that allow information from a nonvolatile removable media device, such as a CD-ROM or DVD, or the like, to be placed on a mass storage device. Once the information from the non-volatile removable media device is on the mass storage device, a computer operating system can then use the information in the same manner as it would normally use a CD-ROM, DVD, or other media inserted in its reader. In accordance with the present invention, the systems, software and methods are operative to create a boot engineering extension record (BEER) on the hard disk drive. The boot engineering extension record is configured to have SETMAX pointer that points to a user area of the hard disk drive and a service area pointer that points to a PARTIES service area that is part of a host protected area. Data derived from the removable storage media device is stored in the PARTIES service area, which will be used in an emulated removable storage media device. An operating system is configured to access 24 the PARTIES service area so that the data that emulates the removable storage media device is available to a user. The operating system is also configured to access the user area, which provides for access to user applications and user data of a user of the computer system.

### BACKGROUND

The present invention relates generally to computer systems, software and methods, and more particularly, to computer systems, software and methods that allow information from a non-volatile removable media device to be placed on a mass storage device.

The Protected Area Run Time Interface Extension Services standard, known as PARTIES (ANSI BSR NCITS-346), provides a mechanism for storing data in a private area, called a service area, of a hard disk drive. The PARTIES standard also provides a method for booting an operating system from a service area. However, the ANSI BSR NCITS-346 PARTIES standard does not provide a mechanism for emulating different types of devices from a hard drive.

It is an objective of the present invention to provide for computer systems, software and methods that allow information from a non-volatile removable media device to be placed on a non-volatile storage device.

### SUMMARY OF THE INVENTION

To accomplish the above and other objectives, the present invention provides for computer systems, software and methods that allow information from a non-volatile removable media device, such as a CD-ROM or DVD, or the like, to be placed on a mass storage device. Once the information from the non-volatile removable media device is on the non-volatile storage device, a computer operating system can then use the information in the same manner as it would normally use a CD-ROM, DVD, or other media inserted in its reader.

An exemplary computer system comprises a central processing unit, a system memory, a nonvolatile storage device and an operating system. The computer system also comprises computer software in accordance with the present invention including code segments that (1) create a boot engineering extension record (BEER) on the nonvolatile storage device, (2) configure the boot engineering extension record to have SETMAX pointer that points to a user area of the hard disk drive and a service area pointer that points to a PARTIES service area that is part of a host protected area of the nonvolatile storage device, (3) stores data derived from the removable storage media device in the PARTIES service area, which data will be used in an emulated removable storage media device, and (4) configures an operating system to access the PARTIES service area so that it is presented to a user as being derived from an emulated removable storage media device. Another code segment may be provided that configures the operating system to access the user area to provide access to applications and data of a user of the computer system.

An exemplary method comprises the following steps. A boot engineering extension record (BEER) is created on the hard disk drive. The boot engineering extension record is configured to have SETMAX pointer that points to a user area of the hard disk drive and a service area pointer that points to a PARTIES service area that is part of a host protected area. Data derived from the removable storage media device is stored in a PARTIES service area, which data will be used in an emulated removable storage media device. An operating system is configured to access the PARTIES service area so that the data stored therein is presented to a user as if it were derived from an emulated removable storage media device. The operating system is also configured to access the user area, which provides for access to user applications and user data of a user of the computer system.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates an exemplary computer system that is implemented in accordance with the principles of the present invention;

FIG. 2 illustrates a portion of a computer system implemented in accordance with the principles of the present invention having a hard disk drive that is formatted using the PARTIES specification; and

FIG. 3 is a flow diagram that illustrates an exemplary method in accordance with the principles of the present invention.

### DETAILED DESCRIPTION

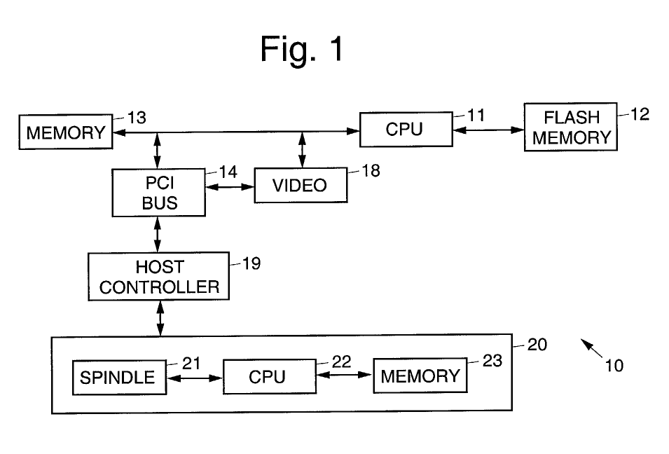

Referring to the drawing figures, FIG. 1 illustrates an exemplary computer system 10 that is implemented in accordance with the principles of the present invention. The computer system 10 comprises a central processing unit (CPU) 11 that is coupled to a critical nonvolatile storage device 12. The critical nonvolatile storage device 12 may be flash memory, a read only memory (ROM), a programmable read only memory (PROM), an erasable programmable read only memory (EPROM), an electrically erasable programmable read only memory (EEPROM), or other device or technology that the CPU 11 can use to execute an initial set of instructions.

The CPU 11 is also coupled to a system memory 13, such as a random access memory 13. The CPU 11 may be coupled to a secondary nonvolatile storage device 20 by way of a system bus 14, such as a Peripheral Component Interconnect (PCI) bus 14, for example. The secondary nonvolatile storage device 20 may be a hard disk drive, a compact disk (CD) drive, a digital video disk (DVD) drive, a floppy disk drive, a Zip drive, a SuperDisk drive, a Magneto-Optical disk drive, a Jazz drive, a high density floppy disk (HiFD) drive, flash memory, read only memory (ROM), programmable read only memory (PROM), erasable programmable read only memory (EPROM), electrically erasable programmable read only memory (EEPROM), or any other device or technology capable of preserving data in the event of a power-off condition.

A first portion of the critical nonvolatile storage device 12 stores initialization code that is operative to initializes the CPU 11 and the system memory 13. A second portion of the critical nonvolatile storage device 12 stores a dispatch manager that contains a list of tasks, which must execute to fully initialize the computer 10. The dispatch manager is operative to selectively load and iteratively execute a number of tasks relating to complete initialization of the computer.

In operation, when the computer 10 is turned on, the initialization code is run to initialize the CPU 11 and the system memory 13. The dispatch manager is then loaded into the system memory 13. The dispatch manager executes the list of tasks contained therein to cause all required firmware (BIOS modules) to be loaded into the system memory 13 and must be executed.

The dispatch manager determines whether each required BIOS module in the system memory 13, and if it is not, finds, loads and executes each required BIOS module. The BIOS modules may be located in the critical nonvolatile storage device 12 (flash memory) or in the secondary nonvolatile storage device 20, including any of the critical or secondary nonvolatile storage devices 20 identified above.

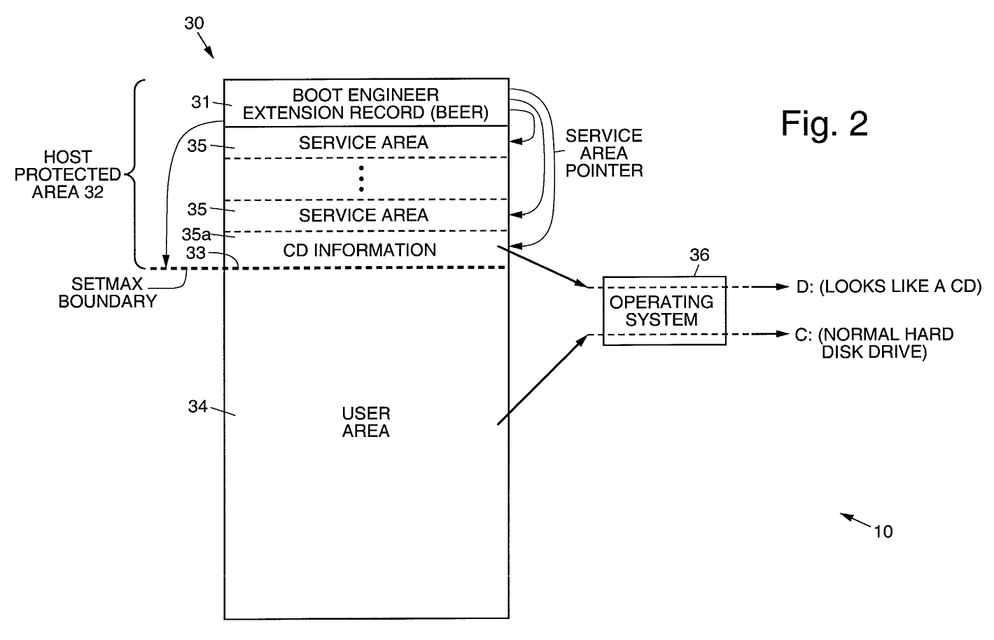

FIG. 2 illustrates a portion of the computer system 10 implemented in accordance with the principles of the present invention having a nonvolatile storage device 20, comprising a hard disk drive 20, or mass storage device 20, that is formatted using a Protected Area Run Time Interface Extension Services (PARTIES) standard, defined by ANSI BSR NCITS-346. The computer system 10 is shown to include an operating system 36.

In accordance with the principles of the present invention, the hard disk drive 20 is configured in accordance the PARTIES standard to have a Boot Engineering Extension Record (BEER) 31. The Boot Engineering Extension Record 31 points to a SETMAX boundary 33 that separates a host protected area 32 from a user accessible area 34. The host protected area 32 comprises a number of services areas 35 including a PARTIES service area 35a (identified with the title “CD INFORMATION” in FIG. 2).

The hard disk drive 20 is thus formatted so that there is a host protected area 32 that is separated from a user accessible area 34 using a SETMAX command. The SETMAX command generates a SETMAX marker 33 or boundary 33 on the hard disk drive 20 beyond which a user cannot access. Thus, the user only has access to hard disk drive space or media space below the SETMAX marker 33.

In accordance with the present invention, a portion of the host protected area 32 is configured to store information derived from the removable storage media device, which emulates the removable storage media device. The portion of the host protected area 32 reserved for the information from the removable storage media device is referred to as the PARTIES service area 35a. The information on the emulated removable storage media device in the PARTIES service area 35a is then accessible to the operating system 36, along with applications and user data in the user area 34 to a user of the computer system 10.

More particularly, the contents of a compact disk (CD), digital video disk (DVD), or other removable storage media device are transferred from the media to a PARTIES service area 35a on the hard disk drive 20. Once data has been transferred from the removable storage media device to the PARTIES service area 35a, a system BIOS, or operating system drive (D:, for example), can make the data look-like the media that the information originated on.

For instance, a CD having a 2 k sector size, may be transferred sector-for-sector into a service area 35 (the PARTIES service area 35a) on a hard disk drive 20 having 512 byte sectors. Once the data has been transferred to the PARTIES service area 35a on the hard disk drive 20, the BIOS can read this data and present a device that looks like a CD-ROM drive. The system BIOS can then boot from the emulated CD-ROM.

A further application of the present invention is for the computer system 10 to boot from the hard disk drive 20 as it normally would. Once the computer system 10 has booted, the operating system 36 can load a driver that reads the information from the PARTIES service area 35a of the hard disk drive 20 and inform the operating system 36 that a CD is present and available for use. If the operating system 36 is a Windows 98 or Windows 2000 operating system 36, for example, and an AUTORUN.INF file is present in the information found in the service area 35a, then the Windows operating system 36 would automatically execute the AUTORUN.INF file and begin doing whatever the CD was supposed to do.

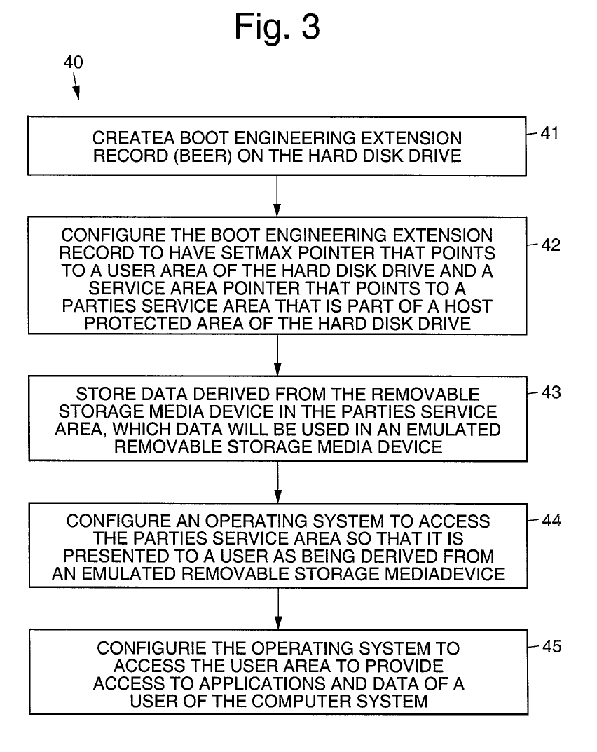

With the above in mind, and referring to FIG. 3, it is a flow diagram that illustrates an exemplary method 40 in accordance with the principles of the present invention. The exemplary method 40 comprises the following steps.

A boot engineering extension record (BEER) 31 is created 41 on the hard disk drive 20. The boot engineering extension record 31 is configured 42 to have SETMAX pointer that points to a user area 34 of the hard disk drive 20 and a service area pointer that points to a PARTIES service area 35a that is part of a host protected area 32.

Data derived from the removable storage media device is stored 43 in the PARTIES service area 35a, which data will be used in an emulated removable storage media device. An operating system 36 is configured to access 44 the PARTIES service area 35a so that the data stored therein is presented to a user as if it were derived from an emulated removable storage media device. The operating system 36 is also configured to access 45 the user area 34 which provides for access to user applications and user data of a user of the computer system 10.

The present invention also embodies computer software for use with a computer system having an operating system and a hard disk drive that implements the above-described method 40. The computer software comprises a code segment that creates a boot engineering extension record (BEER) on the hard disk drive. Another code segment configures the boot engineering extension record to have SETMAX pointer that points to a user area of the hard disk drive and a service area pointer that points to a PARTIES service area that is part of a host protected area of the hard disk drive. Another code segment stores data derived from the removable storage media device in the PARTIES service area, which data will be used in an emulated removable storage media device. Another code segment configures an operating system to access the data in the PARTIES service area so that it is presented to a user as being derived from an emulated removable storage media device. Another code segment may be provided that configures the operating system to access the user area to provide access to applications and data of a user of the computer system.

This present invention assumes the existence of the PARTIES protected area 35 on the hard disk drive 20. In order to access the CD information during operation of the operating system 36, there must be a way to grant access to the data. This method is the subject of U.S. patent application Ser. No. 09/810,731, filed Mar. 16, 2001, entitled “Method of Storing BIOS Modules and Transferring Them to Memory for Execution”, which is assigned to the assignee of the present invention, the subject matter of which is incorporated herein by reference in its entirety.

The present invention allows the information that is copied to the non-volatile storage device 20, or hard disk drive 20, to be compressed. This causes the image copied to the mass storage device 20 to occupy less space. The corresponding component that presents the emulated CD decompresses the image.

The present invention provides a number of useful benefits. Under some conditions, the present invention eliminates the need to physically reproduce CD's, DVD's, or other removable media. Among other things, this allows a system manufacturer to place recovery CD's on the hard disk drive 20. This saves the cost of CD production.

In addition, the present invention can increase system performance. Hard disk drives 20 transfer data more quickly than CD's, DVD's, floppies, Zip drives, or many other types of removable media devices. The present invention allows the computer system 10 to process data at hard disk drive transfer rates instead of removable media drive transfer rates. Furthermore, data can be compressed and will therefore take up les space than it did on the original media.

The present invention provides the following capabilities, which work equally well for all removable media including compact disk (CD), digital video disk (DVD), floppy, Zip, SuperDisk, HiFD, magneto-optical (MO), and other removable media. The present invention is operative to store all or part of data stored on a removable medium on a hard disk drive 20. The present invention is operative to store all or part of data stored on a removable medium in a protected area of a hard disk drive 20. The present invention is operative to compress the information from the removable medium to use less space. The present invention is operative to emulate a removable medium from data stored on a hard disk drive 20.

The present invention is operative to emulate a removable medium using a secure access method. The present invention is operative to automatically run a program from an emulated removable medium once the operating system 16 is booted (Autorun is part of the boot process). The present invention is operative to automatically run an application when an emulated removable medium is initiated (Autorun after the boot process).

Thus, methods that allow information from a non-volatile removable media device to be placed on a mass storage device have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A method for use with a computer system having an operating system and a nonvolatile storage device, comprising the steps of:
creating a boot engineering extension record (BEER) on the nonvolatile storage device;
configuring the boot engineering extension record to have SETMAX pointer that points to a user area of the nonvolatile storage device and a service area pointer that points to a PARTIES service area that is part of a host protected area of the nonvolatile storage device;
storing data derived from the removable storage media device in the PARTIES service area, which data will be used in an emulated removable storage media device; and
configuring an operating system to access the PARTIES service area so that the data stored therein is presented to a user as if it were derived from an emulated removable storage media device.

2. The method recited in claim 1 further comprising the step of:
configuring the operating system to access the user area to provide access to applications and data of a user of the computer system.

3. Computer software for use with a computer system having an operating system and a nonvolatile storage device, comprising:
a code segment that creates a boot engineering extension record (BEER) on the nonvolatile storage device;
a code segment that configures the boot engineering extension record to have SETMAX pointer that points to a user area of the hard disk drive and a service area pointer that points to a PARTIES service area that is part of a host protected area of the nonvolatile storage device;
a code segment that stores data derived from the removable storage media device in the PARTIES service area, which data will be used in an emulated removable storage media device; and
a code segment that configures an operating system to access the PARTIES service area so that it is presented to a user as being derived from an emulated removable storage media device.

4. The computer software recited in claim 3 further comprising a code segment that configures the operating system to access the user area to provide access to applications and data of a user of the computer system.

5. A computer system comprising
a central processing unit;
a system memory;
a nonvolatile storage device;
an operating system; and
computer software that creates a boot engineering extension record (BEER) on the nonvolatile storage device, configures the boot engineering extension record to have SETMAX pointer that points to a user area of the hard disk drive and a service area pointer that points to a PARTIES service area that is part of a host protected area of the nonvolatile storage device, stores data derived from the removable storage media device in the PARTIES service area, which data will be used in an emulated removable storage media device, and configures an operating system to access the PARTIES service area so that it is presented to a user as being derived from an emulated removable storage media device.

6. The computer system recited in claim 5 wherein the computer software also configures the operating system to access the user area to provide access to applications and data of a user of the computer system.
